(19) United States
(12) Patent Application Publication
(10) Pub. No.: US 2018/0302924 A1
(43) Pub. Date: Oct. 18, 2018

(54) METHOD FOR PERFORMING RANDOM ACCESS IN WIRELESS LAN SYSTEM AND APPARATUS THEREFOR

(71) Applicant: LG ELECTRONICS INC., Seoul (KR)

(72) Inventors: Jeongki KIM, Seoul (KR); Kiseon RYU, Seoul (KR); Hangyu CHO, Seoul (KR)

(73) Assignee: LG ELECTRONICS INC., Seoul (KR)

(21) Appl. No.: 15/767,344

(22) PCT Filed: Oct. 26, 2016
(86) PCT No.: PCT/KR2016/012081

§ 371 Date: Apr. 10, 2018

Related U.S. Application Data
(60) Provisional application No. 62/246,151, filed on Oct. 26, 2015.
(60) Provisional application No. 62/246,637, filed on Oct. 27, 2015.
(60) Provisional application No. 62/312,902, filed on Mar. 24, 2016.
(60) Provisional application No. 62/326,844, filed on Apr. 25, 2016.
(60) Provisional application No. 62/372,330, filed on Aug. 9, 2016.
(60) Provisional application No. 62/375,452, filed on Aug. 16, 2016.
(60) Provisional application No. 62/403,654, filed on Oct. 3, 2016.

(51) Int. Cl. H04W 74/08

(52) U.S. Cl. CPC H04W 74/08; H04W 84/12

(57) ABSTRACT

The present document relates to a method for performing random access in a wireless LAN system and an apparatus therefor. To this end, a station (STA) may: receive, from an AP, a first trigger frame for assigning at least one of multiple resource units (RUs) for random access; randomly select one of the at least one RU for random access when a first counter, which is set for the STA, becomes 0; and when it is determined that an uplink frame cannot be transmitted through the randomly selected RU, reselect an RU on the basis of a second trigger frame subsequent to the first trigger frame, wherein, in reselecting the RU, the STA may randomly set the first counter again and delay the reselection of the RU on the basis of the first counter which has been randomly set again.

### TECHNICAL FIELD

The following description relates to a method of efficiently performing random access in a wireless local area network (WLAN) system and an apparatus therefor.

### BACKGROUND ART

Standards for the WLAN technology have been developed as Institute of Electrical and Electronics Engineers (IEEE) 802.11 standards. IEEE 802.11a and b use an unlicensed band at 2.4 GHz or 5 GHz. IEEE 802.11b provides a transmission rate of 11 Mbps and IEEE 802.11a provides a transmission rate of 54 Mbps. IEEE 802.11g provides a transmission rate of 54 Mbps by applying Orthogonal Frequency Division Multiplexing (OFDM) at 2.4 GHz. IEEE 802.11n provides a transmission rate of 300 Mbps for four spatial streams by applying Multiple Input Multiple Output (MIMO)-OFDM. IEEE 802.11n supports a channel bandwidth of up to 40 MHz and, in this case, provides a transmission rate of 600 Mbps.

Since the above-described standards for the WLAN technology maximally use bandwidth of 160 MHz and support eight spatial streams, IEEE 802.11ax standardization is being discussed in addition to IEEE 802.11ac standard maximally supporting a rate of 1 Gbit/s.

### DISCLOSURE

### Technical Problem

In IEEE 802.11ax standardization, it is expected that a random access scheme will be used for signal transmission of stations (STAs) that have not accessed an access point (AP). Random access performed in a state in which the AP cannot provide detailed scheduling information to the STAs may cause collision between the STAs. Accordingly, a method and an apparatus for efficiently controlling occurrence of collision are needed.

### Technical Solution

According to one aspect of the present invention to solve the aforementioned technical problem, a method for performing random access to an AP (Access Point), by a station (STA) operating in a wireless LAN (WLAN) system comprises receiving a first trigger frame allocating at least one resource unit (RU) for random access among a plurality of RUs; randomly selecting one of the at least one RU for random access when a first counter configured in the STA becomes 0; and reselecting a RU on based on a second trigger frame subsequent to the first trigger frame when it is determined that an uplink frame cannot be transmitted through the randomly selected RU, wherein in reselecting the RU, the STA may randomly reconfigure the first counter and defers the reselection of the RU based on the randomly reconfigured first counter.

According to another aspect of the present invention to solve the aforementioned technical problem, a station (STA) for performing random access in a wireless LAN (WLAN) system comprises a receiver for receiving a first trigger frame for allocating at least one RU for random access among a plurality of RUs; and a processor for randomly selecting one of the at least one RU for random access when a first counter configured in the STA becomes 0, and reselecting a RU based on a second trigger frame subsequent to the first trigger frame when it is determined that an uplink frame cannot be transmitted through the randomly selected RU, wherein, in reselecting the RU, the processor randomly reconfigures the first counter and defers the reselection of the RU on the basis of the randomly reconfigured first counter.

Preferably, in randomly reconfiguring the first counter, the STA may reconfigure an upper limit allowed for the first counter, or may configure the upper limit allowed for the first counter to be identical to a current OFDMA contention window (OCW) value set to the STA.

Also, the reconfigured upper limit of the first counter may correspond to two times of the current OCW value set to the STA, or a minimum OCW value set to the STA.

Also, the STA may determine that the uplink frame cannot be transmitted if the randomly selected RU is busy or a size of the randomly selected RU is not sufficient for transmission of the uplink frame.

Also, the first trigger frame or the second trigger frame may include at least one of a first field indicating whether the STA should perform carrier sensing for random access and a second field indicating whether the STA should select only RU belonging to an idle channel except a busy channel.

Also, the carrier sensing may include at least one of virtual carrier sensing based on NAV (network allocation) and physical carrier sensing based on CCA-ED (clear channel assessment-energy detection).

Also, a backoff procedure RU based on the first counter and the random selection of the may be performed only if NAV is 0.

Also, whether the randomly selected RU is busy may be determined based on a result of the physical carrier sensing.

According to still another aspect of the present invention, an AP for supporting the STA to perform random access and a method therefor may be provided.

### Advantageous Effects

According to one embodiment of the present invention, if an AP provides an STA with control information for random access through a trigger frame, the STA may perform random access on the basis of carrier sensing, thereby minimizing collision with another STA.

### BRIEF DESCRIPTION OF THE DRAWINGS

FIG. 1 is a diagram illustrating an exemplary configuration of a Wireless Local Area Network (WLAN) system.

FIG. 2 is a diagram illustrating another exemplary configuration of a WLAN system.

FIG. 3 is a diagram illustrating an exemplary structure of a WLAN system.

FIG. 4 is a diagram for explaining a general link setup process.

FIG. 5 is a diagram for explaining active scanning and passive scanning methods.

FIG. 6 is a diagram schematically illustrating a random access procedure according to an embodiment of the present invention

FIG. 7 is a diagram illustrating a DCF mechanism in a WLAN system.

FIG. 8 is a diagram illustrating a method of performing a random access procedure based on CCA according to an embodiment of the present invention.

FIGS. 9 and 10 are diagrams illustrating transmission delay of a random access frame considering a result of CCA according to an embodiment of the present invention.

FIGS. 11 and 12 are diagrams illustrating a method of performing random access based on a predetermined rule when a randomly selected resource is in a busy state according to an embodiment of the present invention.

FIGS. 13 and 14 are diagrams illustrating a method of selecting a randomly selected resource from among idle resources according to an embodiment of the present invention.

FIG. 15 is a diagram illustrating an STA operation based on an RA mode according to one embodiment of the present invention.

FIG. 16 is a diagram illustrating an STA operation based on an RA mode according to another embodiment of the present invention.

FIG. 17 is a diagram illustrating an OFDMA based random access procedure according to one embodiment of the present invention.

FIG. 18 is a diagram illustrating an apparatus for implementing the aforementioned method.

### MODE FOR INVENTION

Reference will now be made in detail to the exemplary embodiments of the present invention with reference to the accompanying drawings. The detailed description, which will be given below with reference to the accompanying drawings, is intended to explain exemplary embodiments of the present invention, rather than to show the only embodiments that can be implemented according to the invention.

The following detailed description includes specific details in order to provide a thorough understanding of the present invention. However, it will be apparent to those skilled in the art that the present invention may be practiced without such specific details. In some instances, known structures and devices are omitted or are shown in block diagram form, focusing on important features of the structures and devices, so as not to obscure the concept of the present invention.

As described above, the following description relates to a method of efficiently performing random access by STAs in a WLAN system and an apparatus therefor. To this end, the WLAN system to which the present invention is applied will not be described in detail.

FIG. 1 is a diagram illustrating an exemplary configuration of a WLAN system.

As illustrated in FIG. 1, the WLAN system includes at least one Basic Service Set (BSS). The BSS is a set of STAs that are able to communicate with each other by successfully performing synchronization.

An STA is a logical entity including a physical layer interface between a Media Access Control (MAC) layer and a wireless medium. The STA may include an AP and a non-AP STA. Among STAs, a portable terminal manipulated by a user is the non-AP STA. If a terminal is simply called an STA, the STA refers to the non-AP STA. The non-AP STA may also be referred to as a terminal, a Wireless Transmit/Receive Unit (WTRU), a User Equipment (UE), a Mobile Station (MS), a mobile terminal, or a mobile subscriber unit.

The AP is an entity that provides access to a Distribution System (DS) to an associated STA through a wireless medium. The AP may also be referred to as a centralized controller, a Base Station (BS), a Node-B, a Base Transceiver System (BTS), or a site controller.

The BSS may be divided into an infrastructure BSS and an Independent BSS (IBSS).

The BSS illustrated in FIG. 1 is the IBSS. The IBSS refers to a BSS that does not include an AP. Since the IBSS does not include the AP, the IBSS is not allowed to access to the DS and thus forms a self-contained network.

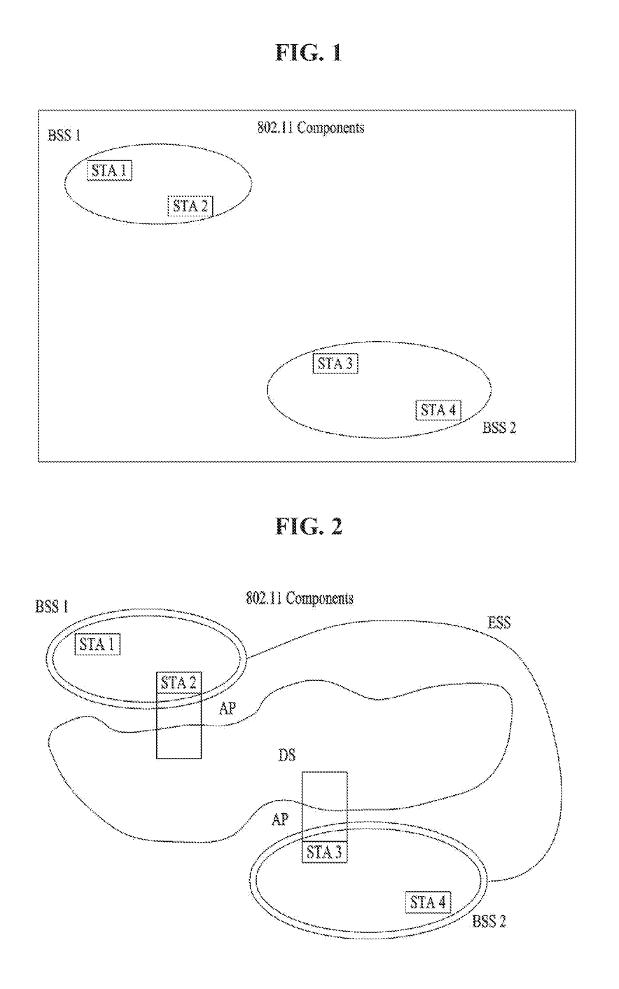

FIG. 2 is a diagram illustrating another exemplary configuration of a WLAN system.

BSSs illustrated in FIG. 2 are infrastructure BSSs. Each infrastructure BSS includes one or more STAs and one or more APs. In the infrastructure BSS, communication between non-AP STAs is basically conducted via an AP. However, if a direct link is established between the non-AP STAs, direct communication between the non-AP STAs may be performed.

As illustrated in FIG. 2, the multiple infrastructure BSSs may be interconnected via a DS. The BSSs interconnected via the DS are called an Extended Service Set (ESS). STAs included in the ESS may communicate with each other and a non-AP STA within the same ESS may move from one BSS to another BSS while seamlessly performing communication.

The DS is a mechanism that connects a plurality of APs to one another. The DS is not necessarily a network. As long as it provides a distribution service, the DS is not limited to any specific form. For example, the DS may be a wireless network such as a mesh network or may be a physical structure that connects APs to one another.

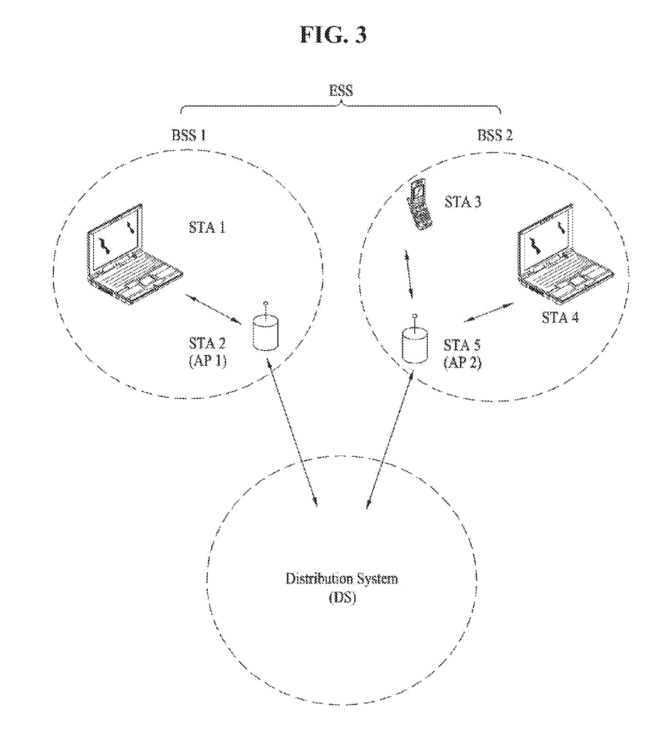

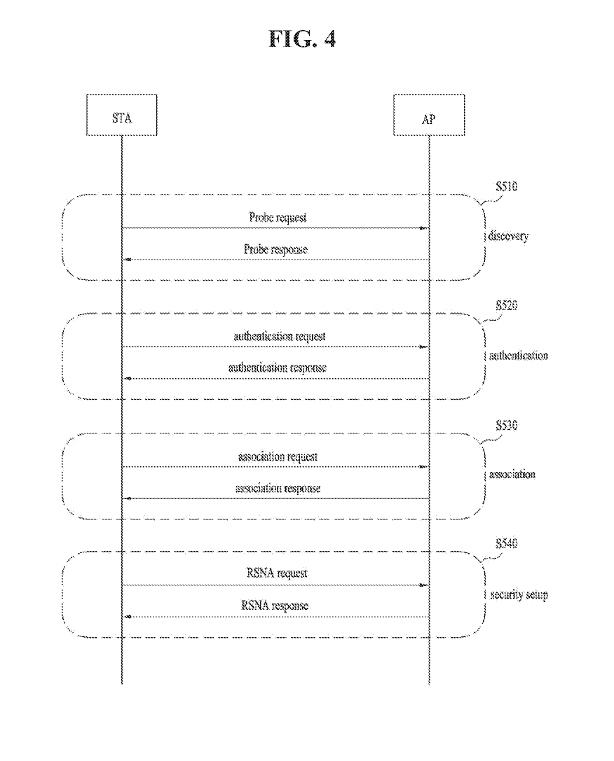

FIG. 3 is a diagram illustrating an exemplary structure of a WLAN system. FIG. 3 shows an example of an infrastructure BSS including a DS.

In the example of FIG. 3, BSS1 and BSS2 configure an ESS. In the WLAN system, a station operates according to MAC/PHY rules of IEEE 802.11. The station includes an AP station and a non-AP station. The non-AP station corresponds to an apparatus directly handled by a user, such as a laptop or a mobile telephone. In the example of FIG. 3, a station 1, a station 3 and a station 4 are non-AP stations and a station 2 and a station 5 are AP stations.

In the following description, the non-AP station may be referred to as a terminal, a wireless transmit/receive unit (WTRU), a user equipment (UE), a mobile station (MS), a mobile terminal, a mobile subscriber station (MSS), etc. In addition, the AP corresponds to a base station (BS), a node-B, an evolved node-B (eNB), a base transceiver system (BTS), a femto BS, etc. in different wireless communication fields.

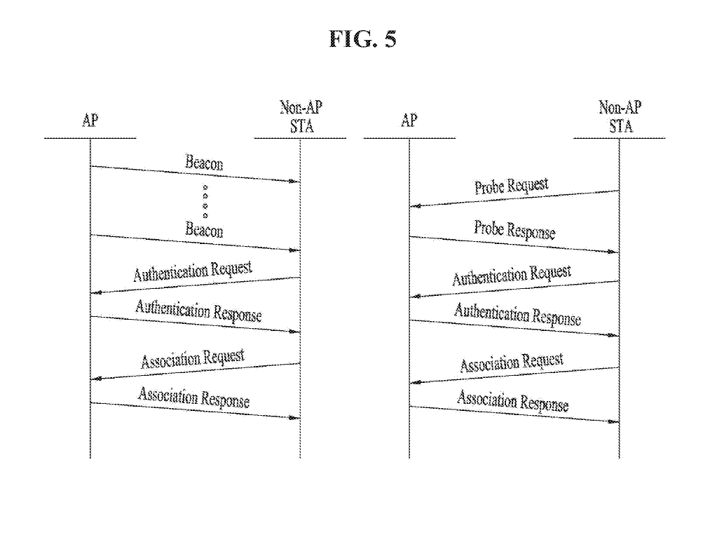

FIG. 4 is a diagram for explaining a general link setup process and FIG. 5 is a diagram for explaining active scanning and passive scanning methods.

To establish a link with a network and perform data transmission and reception, an STA discovers the network, performs authentication, establishes association and performs an authentication process for security. The link setup process may be referred to as a session initiation process or a session setup process. In addition, discovery, authentication, association and security setup of the link setup process may be collectively referred to as an association process.

An exemplary link setup process will be described with reference to FIG. 4.

In step S510, the STA may perform a network discovery operation. The network discovery operation may include a scanning operation of the STA. That is, the STA discovers the network in order to access the network. The STA should identify a compatible network before participating in a wireless network and a process of identifying a network present in a specific area is referred to as scanning.

The scanning method includes an active scanning method and a passive scanning method. Although FIG. 4 shows a network discovery operation including an active scanning process, the network discovery operation can be performed through a passive scanning process.

In active scanning, the STA which performs scanning transmits a probe request frame while moving between channels and waits for a response thereto, in order to detect which AP is present. A responder transmits a probe response frame to the STA, which transmitted the probe request frame, as a response to the probe request frame. The responder may be an STA which lastly transmitted a beacon frame in a BSS of a scanned channel. In the BSS, since the AP transmits the beacon frame, the AP is the responder. In the IBSS, since the STAs in the IBSS alternately transmit the beacon frame, the responder is not fixed. For example, the STA which transmits the probe request frame on a first channel and receives the probe response frame on the first channel stores BSS related information included in the received probe response frame, moves to a next channel (e.g., a second channel) and performs scanning (probe request/response transmission/reception on the second channel) using the same method.

In addition, referring to FIG. 5, a scanning operation may be performed using a passive scanning method. In passive scanning, the STA which performs scanning waits for a beacon frame while moving between channels. The beacon frame is a management frame in IEEE 802.11 and is periodically transmitted in order to indicate presence of a wireless network and to enable the STA, which performs scanning, to discover and participate in the wireless network. In the BSS, the AP is responsible for periodically transmitting the beacon frame. In the IBSS, the STAs alternately transmit the beacon frame. The STA which performs scanning receives the beacon frame, stores information about the BSS included in the beacon frame, and records beacon frame information of each channel while moving to another channel. The STA which receives the beacon frame may store BSS related information included in the received beacon frame, move to a next channel, and perform scanning on the next channel using the same method.

Compared to the passive scanning, the active scanning has a small delay and less power consumption.

After the STA has discovered the network, an authentication process may be performed in step S520. Such an authentication process may be referred to as a first authentication process to be distinguished from a security setup operation of step S540, which will be described later.

The authentication process includes the following processes. The STA transmits an authentication request frame to the AP and then, the AP transmits an authentication response frame to the STA in response to the authentication request frame. The authentication frame used for authentication request/response corresponds to a management frame.

The authentication frame may include information on an authentication algorithm number, an authentication transaction sequence number, a status code, a challenge text, a robust security network (RSN), a finite cyclic group, etc. Such information is merely an example of information included in the authentication request/response frame and can be replaced with different information. Moreover, additional information may be further included.

The STA may transmit the authentication request frame to the AP. The AP may determine whether authentication of the STA is allowed, based on the information included in the received authentication request frame. The AP may provide the STA with the authentication result through the authentication response frame.

After the STA is successfully authenticated, an association process may be performed in step S530. The association process includes the following processes. The STA transmits an association request frame to the AP and the AP transmits an association response frame to the STA in response thereto.

For example, the association request frame may include information on a variety of capabilities, beacon listen interval, service set identifier (SSID), supported rates, RSN, mobility domain, supported operating classes, traffic indication map (TIM) broadcast request, interworking service capability, etc.

For example, the association response frame may include information on a variety of capabilities, status code, association ID (AID), supported rates, enhanced distributed channel access (EDCA) parameter set, received channel power indicator (RCPI), received signal to noise indicator (RSNI), mobility domain, timeout interval (association comeback time), overlapping BSS scan parameter, TIM broadcast response, QoS map, etc.

This information is merely an example of information included in the association request/response frame and may be replaced with different information. Moreover, additional information may be further included.

After the STA is successfully associated with the network, a security setup process may be performed in step S540. The security setup process of step S540 may be referred to as an authentication process through a robust security network association (RSNA) request/response. In addition, the authentication process of step S520 may be referred to as the first authentication process and the security setup process of step S540 may be simply referred to as an authentication process.

The security setup process of step S540 may include a private key setup process through 4-way handshaking of an extensible authentication protocol over LAN (EAPOL) frame. In addition, the security setup process may be performed according to a security method which is not defined in the IEEE 802.11 standard.

Hereinafter, random access in the WLAN system introduced in an IEEE 802.11ax system will be explained based on the above description.

Random Access in WLAN System

To raise MAC efficiency, an uplink multi-user (UL MU) protocol such as UL orthogonal frequency division multiple access (OFDMA) or UL MU multiple-input multiple-output (MIMO) may be used in a WLAN. A UL MU PLCP protocol data unit (PPDU) is transmitted as an immediate response (e.g., a short interframe space (SIFS), a PCF interface space (PIFS), etc.) to a trigger frame transmitted by an AP. The AP may allocate an MU resource to a plurality of STAs by including information such as STA IDs and resource units in the trigger frame. However, since the AP cannot allocate a UL MU resource to unassociated STAs or to STAs which are awoken from a sleep state for UL frame transmission, the AP may allocate a random access resource which can be used by all STAs. If the random access resource is allocated, STAs may select a random slot from the allocated resource and transmit a UL frame.

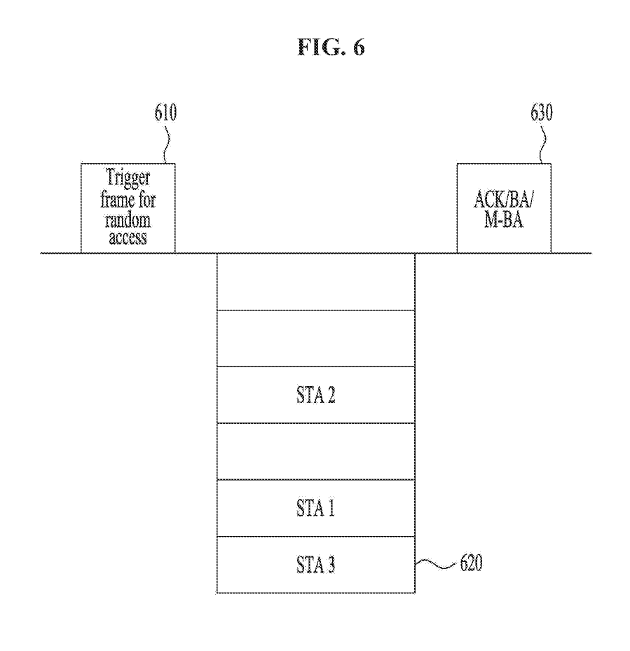

FIG. 6 is a diagram schematically illustrating a random access procedure according to an embodiment of the present invention.

An AP may transmit a trigger frame for random access of STAs (S610). The trigger frame for random access may provide resource allocation information for random access to the STAs. In the example of FIG. 6, the AP allocates 6 resource regions by transmitting the trigger frame. STA2 randomly selects the third resource unit, STA1 selects the fifth resource unit, and STA3 selects sixth resource unit, thereby to transmit frames (S620). Upon frames from the STAs, the AP may transmit an acknowledgement signal (ACK). In some cases, the AP may transmit a block ACK (BA) or multi-user block ACK (M-BA).

Meanwhile, a procedure for preventing collision may be required even in the above-described random access procedure of the WLAN system. In association with the procedure for preventing collision, a distributed coordination function (DCF), which is a carrier sense multiple access/collision avoidance (CSMA/CA) mechanism used in the WLAN system, will now be described.

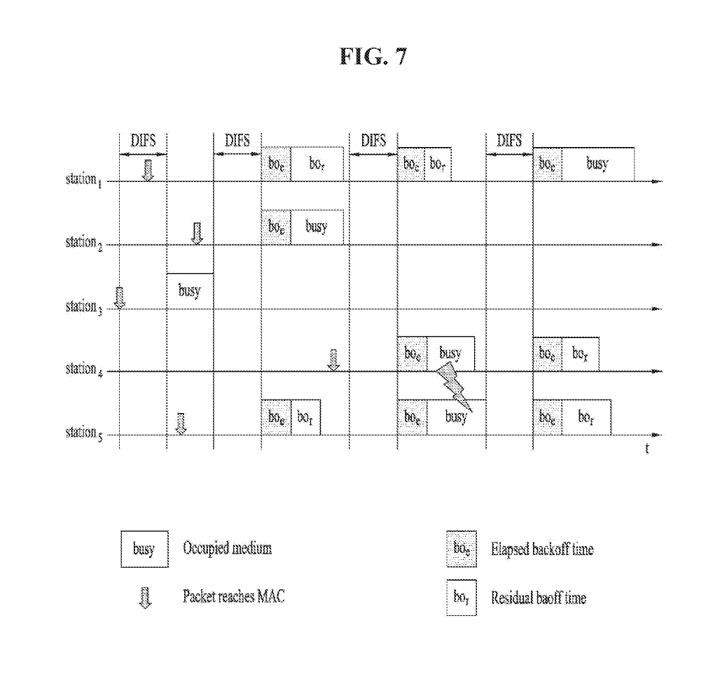

FIG. 7 is a diagram illustrating a DCF mechanism in the WLAN system.

According to the DCF mechanism, STAs having data to be transmitted perform clear channel assessment (CCA) of sensing a medium for a specific duration (e.g., DCF inter-frame space (DIFS)) before transmitting the data. Here, when the medium is idle (usable), an STA may transmit signals using the medium. On the other hand, when the medium is busy (unusable), the STA may transmit data after waiting for DIFS plus a random backoff period on the assumption that several STAs are waiting to use the medium. Herein, the random backoff period enables collision avoidance because STAs stochastically have different backoff interval values and thus have different transmission times on the assumption that multiple STAs to transmit data are present. When an STA starts to transmit data, the other STAs are not allowed to use the medium.

A random backoff time and procedure are briefly described below.

When a specific medium switches from “busy” to “idle”, STAs start to prepare for data transmission. Here, the STAs that attempt to transmit data select respective random backoff counts and wait for corresponding slot times in order to minimize collision. The random backoff count is a pseudo-random integer and each STA selects one uniformly distributed value in the range of [0: CW] as the random backoff count. CW refers to a contention window.

A CW parameter takes a minimum value of CW, CWmin, as an initial value but the initial value is doubled if transmission fails. For example, if an ACK response to a transmitted data frame is not received, it may be considered that collision has occurred. If the CW parameter is a maximum value of CW, CWmax, CWmax is maintained until data transmission is successful and CWmax is reset to CWmin when data transmission is successful.

When a random backoff procedure is started, an STA selects a random backoff count within the range of [0 CW] and then keeps monitoring the medium while counting down a backoff slot. If the medium switches to a busy state in the meantime, the STA stops counting down the backoff slot. The STA resumes counting down of the remaining backoff slot when the medium becomes idle again.

Referring to FIG. 7, when multiple STAs have data to be transmitted, STA3 may immediately transmit a data frame since the medium has been idle for a DIFS and the other STAs wait for the medium to become idle. Since the medium is busy for a while, STAs may watch for an opportunity to use the medium. Accordingly, each STA selects a random backoff count. It can be seen from FIG. 7 that STA2, which has selected the smallest backoff count, transmits a data frame.

After transmission from STA2 is finished, the medium switches back to the idle state and STAs resume counting down of the backoff slot. It can be seen from FIG. 7 that STA5, which has the second smallest random backoff count after that of STA2 and temporarily stops counting down while the medium is busy, counts down the remaining backoff slot and then starts data frame transmission, but collision occurs since the random backoff count of STA5 accidentally overlaps with the random backoff count of STA4. In this case, neither of the two STAs receives ACK response after data transmission and thus the CW is doubled and the STAs re-select random backoff count values.

The most fundamental CSMA/CA is carrier sensing. An STA may use physical carrier sensing and virtual carrier sensing to determine whether a DCF medium is busy or idle. Physical carrier sensing is performed in a PHY stage through energy detection or preamble detection. For example, when it is determined that a receiver has measured a voltage level or read a preamble, the medium may be determined to be busy. Virtual carrier sensing sets a network allocation vector (NAV) to prevent other STAs from transmitting data and is performed according to a duration field value of a MAC header. To decrease collision possibility, a robust collision detection mechanism has been introduced and an operating using a request to send (RTS)/clear to send (CTS) frame has been introduced for the robust collision detection mechanism.

Now, the backoff procedure in random access will be described with reference to FIG. 6 based on the above description.

Upon receiving the trigger frame from the AP, the STAs may perform the backoff procedure based on the size of a backoff contention window size for random access. The size of the backoff contention window is desirably a size corresponding to the number of resource units allocated from the trigger frame. Each of the STAs may perform the backoff procedure based on a backoff value selected in the range of the contention window and transmit a frame, as illustrated in FIG. 6, through a resource randomly selected from among random access resources at a timing when the value of a backoff count reaches 0.

Meanwhile, the random access procedure of the WLAN system has been described on the assumption that backoff is performed in units of allocated resource units without performing CCA. That is, the random access procedure may be performed in a manner of reducing the backoff count with respect to a random access resource allocated to a corresponding STA regardless of whether a medium is busy or idle. Hereinafter, a random access control method considering a busy/idle state of a medium by performing CCA, in addition to the above-described procedure, will be proposed.

CCA Based Random Access

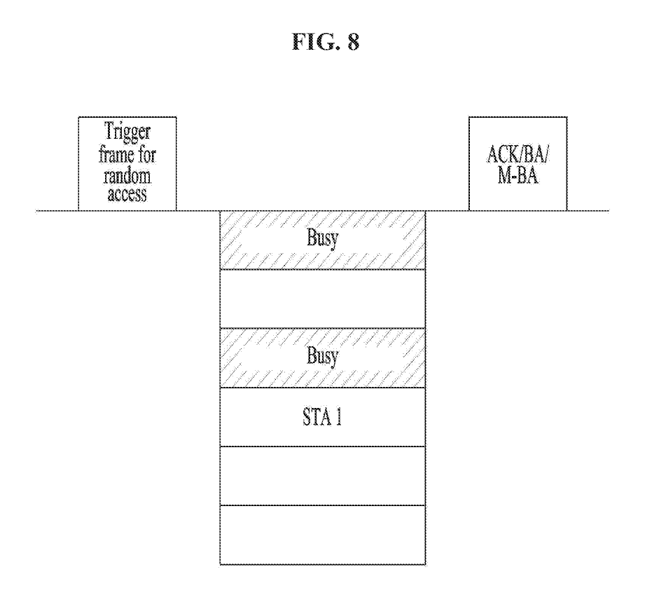

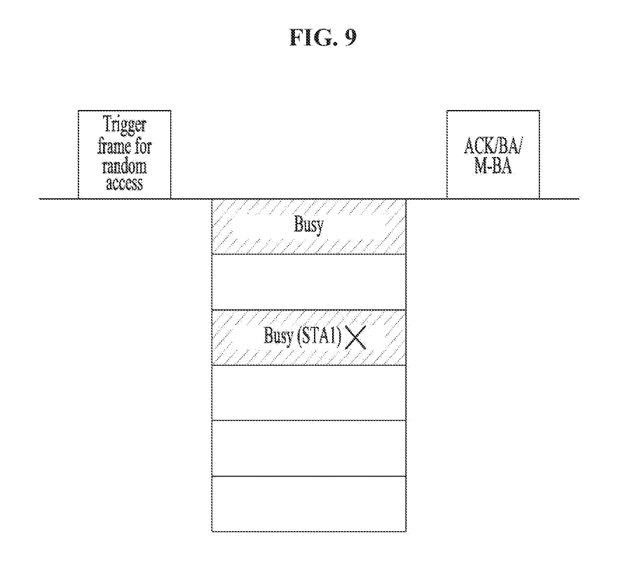

FIG. 8 is a diagram illustrating a method of performing a random access procedure based on CCA according to an embodiment of the present invention.

In this embodiment, STAs check CCA before (or after) receiving a trigger frame for random access. As a result of CCA, it may be determined that first and third slots are busy among 6 random access resource units. In this case, the STAs may select a random access resource in consideration of the result of CCA and transmit a frame through the selected resource.

FIG. 8 illustrates an example in which a randomly selected resource is irrelevant to a busy slot as a result of CCA. That is, since STA 1 has selected the fourth slot as a random selection resource and it has been determined that the fourth slot is idle, STA 1 may transmit a frame through the selected fourth slot.

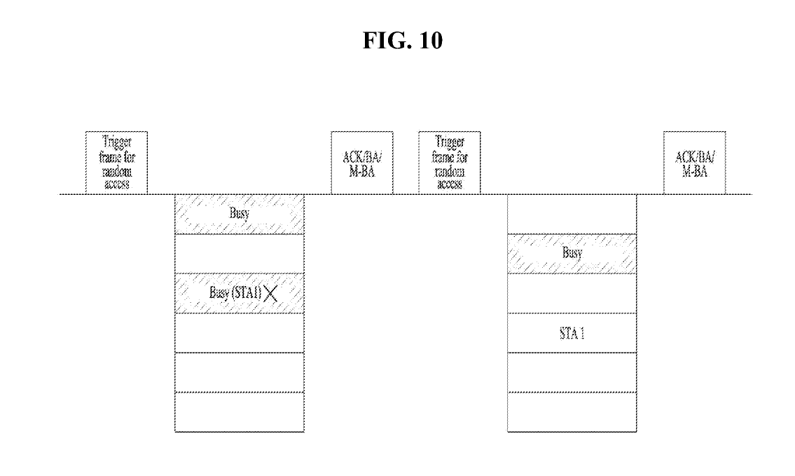

FIGS. 9 and 10 are diagrams illustrating transmission delay of a random access frame considering a result of CCA according to an embodiment of the present invention.

Specifically, referring to FIG. 9, if a randomly selected resource region belongs to a busy channel, an STA does not transmit a random access frame in the selected region. In the example of FIG. 9, since STA 1 has selected a random value 3 but a channel for the selected region is in a busy state, STA1 does not transmit a random access frame in a duration corresponding to a first trigger frame.

In this case, STA 1 re-attempts to transmit the random access frame in a duration corresponding to the next trigger frame as illustrated in FIG. 10. That is, while maintaining a random backoff value 0 of STA1, STA1 may select a resource region in which STA1 is to transmit a frame through random selection in the next trigger frame and then transmit the frame in the selected resource region.

In the example of FIG. 10, STA 1 receives the first trigger frame and attempts to perform random access. While performing random selection, STA 1 selects a random value 3 and tries to transmit a frame. However, since a corresponding resource region belongs to a busy subchannel, STA 1 does not attempt to transmit the frame and delays frame transmission in a corresponding resource region. In this case, while maintaining a random backoff value (i.e., 0), STA 1 may attempt to perform random access in transmission of the next trigger frame (the second trigger frame in the example).

In this case, after receiving the second trigger frame, STA 1 selects a random value in a region allocated by the trigger frame in order to attempt to perform random access and attempts to transmit a frame. In the above example, STA 1 may select a random value 4 in the second trigger frame and transmit a frame because a corresponding channel is idle.

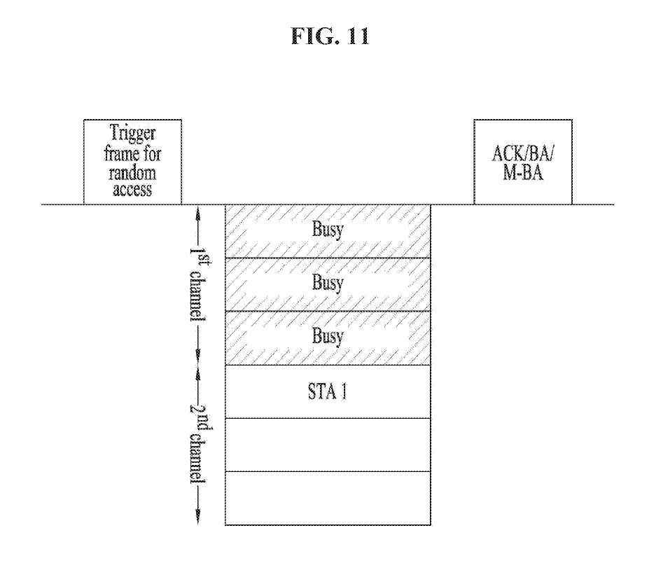

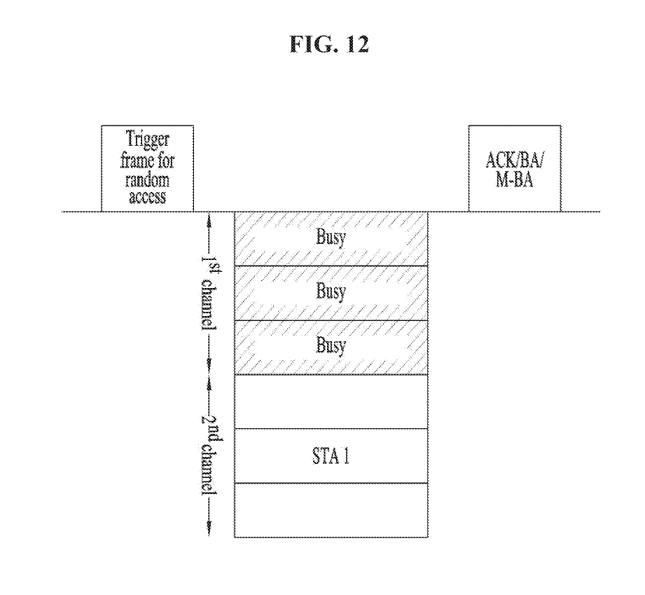

FIGS. 11 and 12 are diagrams illustrating a method of performing random access based on a predetermined rule when a randomly selected resource is in a busy state according to an embodiment of the present invention.

As illustrated in FIG. 11, if a resource region selected by an STA belongs to a busy channel, the STA transmits a frame using the first (or last) resource region (slot) of an idle channel (or from among idle channels) after the selected resource region. However, as described above, a scheme of determining a resource region is not limited to the above example and various schemes may be used.

In FIG. 11, STA 1 selects a random value 3 and the selected third slot is busy. Then, STA 1 selects and uses the first slot of an idle channel (i.e., the fourth resource region in the above example).

Meanwhile, in the example of FIG. 12, if a resource region selected by an STA belongs to a busy channel, the STA may randomly select a resource from among resource regions of an idle channel after the selected resource region and transmit a frame. When one resource region of a channel is present, the frame is transmitted in a corresponding region.

In the example of FIG. 12, STA 1 selects a random value 3 but the selected third slot is in a busy state. Then, STA 1 selects and uses a random resource region of an idle channel (i.e., the second channel) (the second resource region of the second channel in the above example).

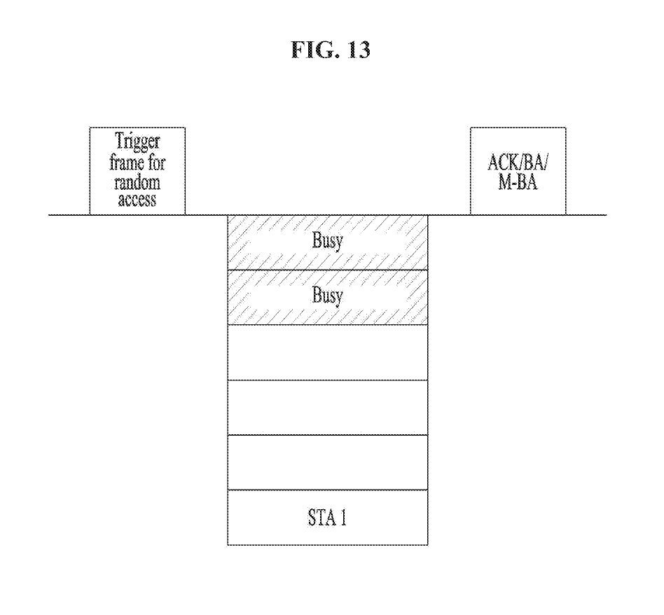

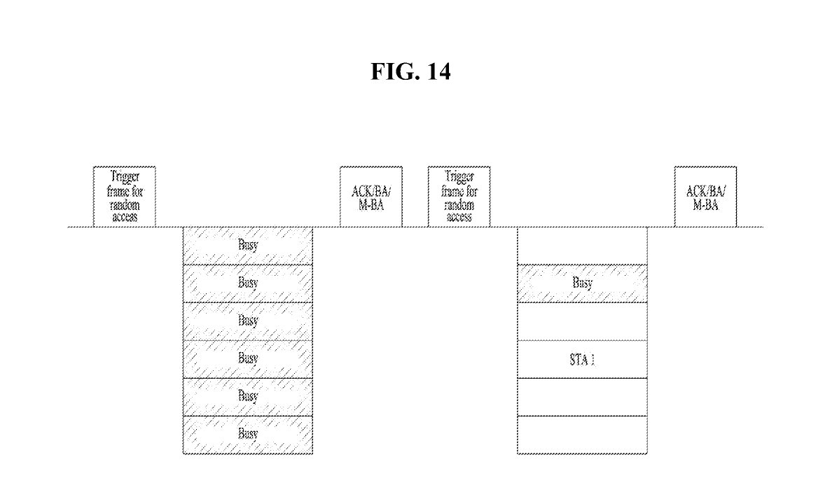

FIGS. 13 and 14 are diagrams illustrating a method of selecting a randomly selected resource from among idle resources according to an embodiment of the present invention.

In this embodiment, STAs check CCA before (or after) receiving a trigger frame for random access. The STAs randomly select a resource slot from among resource regions except for resource regions included in a busy channel among all resource regions allocated by the trigger frame and transmit a frame in the selected resource region.

In the example of FIG. 13, since the first resource region and the second resource region belong to a busy channel, STA 1 transmits a frame using a randomly selected resource region (i.e., the sixth resource region) among resource regions from the third to sixth resource regions.

If there is no idle channel, the STA re-attempts to perform transmission at a timing corresponding to the next trigger frame and this example is illustrated in FIG. 14. That is, while maintaining a random backoff count value 0 of the STA, the STA may select a resource region in which the STA is to perform transmission through random selection in the next trigger frame.

In the above example of FIG. 14, since all channels for all resource units allocated for random access by the first trigger frame are busy, the STA attempts to perform random access in random resource units allocated by the second trigger frame. If some resource units are busy or all resource units are idle in resource units allocated by the second trigger frame, the STA may randomly select one of resource units belonging to an idle channel and transmit a frame through the selected resource unit.

Similarly to the example of FIG. 10, since there is no idle channel after the STA receives the first trigger frame, the STA may select a random value in a region allocated by the second trigger frame and attempt to transmit a frame in order to attempt to perform random access after receiving the second trigger frame. In the above example, since STA 1 selects a random value 4 in the second trigger frame and a corresponding channel is idle, STA 1 may transmit a frame.

The above methods may be applied to the case in which some or all resource regions allocated by a trigger frame belong to a busy channel.

Meanwhile, FIG. 14 illustrates that the STA1 maintains a random backoff count value (0) during a procedure of receiving the second TF (trigger frame) and randomly reselecting RU as an example. However, as another example, the STA1 may randomly reselect the random backoff count value. According to the example that the random backoff count value (0) is maintained, RU is randomly selected without the backoff procedure after the second TF is received. However, according to the example that the random backoff count value is randomly reselected, the backoff procedure is performed prior to RU selection after the second TF is received.

In the aforementioned description, the backoff counter set for OFDMA random access may simply be referred to as an OBO (OFDMA Back-off) counter. Also, a selected range of the OBO counter, that is, a contention window may simply be referred to as an OCW (OFDMA Contention window). Since the OBO counter and the OCW are values for OFDMA random access, they should be identified clearly as separate values from the legacy backoff counter and CW for DCF/EDCAF. Also, the resource slot may be replaced with a resource unit (RU).

The aforementioned description will briefly be summarized as follows.

The AP may allocate RU by transmitting the trigger frame to the STA, and which RU has been allocated to which STA may be indicated through AID. At this time, RU for random access may be indicated by a specific AID value (i.e., AID 0). That is, STA which desires to perform random access may perform random access for the AP through a random access RU allocated through AID 0 even there is no RU allocated as an AID value of the STA.

If the STA has a frame to be transmitted in a random access mode, the STA initiates its OBO counter to a random value selected within the range of [0:OCW]. The STA reduces the OBO counter as much as 1 every random access RU. For example, if the random access RU allocated through the trigger frame is N, it may be understand that the OBO counter is reduced as much as N. If the OBO counter of the STA is n and n<N, the STA may reduce its OBO counter to 0 If the OBO counter is 0, the STA randomly selects any one of the random access RU.

(1) If the STA does need to check CCA before transmitting the frame, the STA transmits the frame through the randomly selected RU.

(2) Unlike this, if the STA needs to check CCA before transmitting the frame, the STA transmits the frame when the randomly selected RU is idle. If the RU selected by the STA is busy, the STA does not transmit the frame through the corresponding RU. In this way, the STA which could not transmit UL frame in accordance with a CCA check result after receiving the first trigger frame performs frame transmission by randomly selecting any one of the random access RU allocated through the second trigger frame (i.e., next trigger frame of the first trigger frame). (i) The method that the STA which has received the second trigger frame randomly selects RU without backoff procedure and (ii) the method that the STA which has received the second trigger frame randomly selects RU after performing the backoff procedure once again may be considered.

(i) As an example, the STA may randomly reselect any one of the random access RU allocated through the second trigger frame in a state that the OBO counter (e.g., 0) is maintained. If the reselected RU is idle, the STA transmits the frame.

(ii) As another example, the STA may randomly reselect the OBO counter. Afterwards, if the reselected OBO counter is 0, the STA randomly selects any one of the random access RU allocated through the second trigger frame, and if the selected RU is idle, the STA transmits the frame. When the STA randomly selects the OBO counter after receiving the second trigger frame, any one of (ii-1), (ii-2) and (ii-3) may be used, and this case is not limited to any one of (ii-1), (ii-2) and (ii-3).

(ii-1) As an example, the STA may select the OBO counter within the range of [0: value 1] by using the current OCW=value 1.

(ii-2) As another example, the STA may reselect the OBO counter after increasing the current OCW (e.g., OCW*2). For example, the STA may select the OBO counter within the range of [0: 2*value 1].

(ii-3) As still another example, the STA may reselect the OBO counter after reducing the current OCW. As a method for reducing OCW, the STA may set the OCW value to OCWmin. For example, the STA may select the OBO counter within the range of [0: OCWmin]. The AP may notify the STA of OCW min which is a minimum value that may be owned by the OCW and OCWmax which is a maximum value that may be owned by the OCW, through a beacon frame or a probe response frame. If the OCW is minimized, the frame transmission of the corresponding STA may be performed quickly, whereby it is advantageous that transmission delay according to random access may be reduced.

Introduction of Method for Setting Random Access Threshold Value

Still another embodiment of the present invention suggests a method for determining whether the STA tries random access to a resource region allocated from a corresponding trigger frame on the basis of a random access threshold value when trying random selection through random access.

For example, if the random access threshold value is determined and a random value selected for random selection exceeds the random access threshold value, the UE delays transmission without trying transmission at the corresponding time, and if the random value is within the random access threshold value, the UE tries transmission in the randomly selected resource region.

This embodiment suggests a method for setting a window, which selects a random value for random access, and a random access threshold value. The window in which the STA selects a random value for random selection is determined by a total number of resource units for random access, which are allocated from the trigger frame. For example, if the total number of resource units for random access, which are allocated from the trigger frame, is 9, the STA selects a random resource region by selecting a random value from 1 to 9.

The random access threshold value is determined by a total number of resource units which belong to an idle channel, among resource units for random access, which are allocated from the trigger frame. For example, if the total number of resource units allocated from the trigger frame is 9 and the number of resource units belonging to an idle channel is 6, a random selection window is set to 9, and the random access threshold value is set to 6.

Under the assumption, if the random value selected by the STA from random selection window (9) is smaller than 6 (or smaller than or equal to 6), the UE may try random access. However, if the selected random value is greater than or equal to 6, it is preferable that the UE does not try random access.

Afterwards, a method for performing transmission through random selection may transmit a frame through one of the methods listed above or another method. In the aforementioned embodiments, it is assumed that the NAV rule for UL MU procedure defined in 11ax is applied as it is. For example, if OBSS NAV is configured, transmission may not be performed even though CCA is idle. If not so, the above rule may be defined as it is.

Indication of Random Access (RA) Mode

According to one embodiment, the AP may indicate a random access mode for the STA. As a random access mode that may be indicated by the AP, option 1 or option 2, which will be described later, may be exemplified, and the present invention is not limited to this example.

Option 1: The STA performs CCA check for a certain time (e.g., SIFS) after receiving the trigger frame for random access. The STA randomly selects RU (resource unit) from resource regions included in an idle channel except a busy channel among all resource regions allocated from the trigger frame.

For example, option 1 will be described with reference to FIG. 13 again. The STA1 excludes first two RUs belonging to the busy channel and randomly selects one of the other RUs for random access to transmit a frame. In FIG. 13, it may be understood that the STA1 has selected a random value 4.

Option 2: The STA randomly selects RU from RUs (i.e., RUs indicated by AID 0) for random access, which are allocated from the trigger frame, after receiving the trigger frame and performing carrier sensing. If the selected RU is included in the busy channel, the STA tries a retransmission procedure without transmitting the frame to the randomly selected RU at the corresponding time. As a retransmission procedure, the following option 2-1, 2-2, 2-3 or 2-4 may be considered, and the present invention is not limited to the option 2-1, 2-2, 2-3, or 2-4.

(i) Option 2-1: The STA randomly again selects RU at next trigger frame and tries transmission.

(ii) Option 2-2: The STA randomly again selects OBO from 0 to OCW values to try transmission by using the current OCW at next trigger frame.

(iii) Option 2-3: The STA randomly again selects OBO from OCW values doubled from the existing OCW at next trigger frame.

(iv) Option 2-4: The STA randomly again selects OBO from 0 to OCW values after setting OCW value to OCWmin at next trigger frame. Alternatively, the STA randomly selects OBO counter from 0 to OCWmin.

The option 1 is a method favorable for improving resource efficiency. Since the STA may immediately perform transmission if there is an idle channel, this option 1 may be a method for increasing efficiency in resource usage in a non-dense environment (e.g., environment that STAs which try random access are not great). However, if many OBSS exist and many STAs for trying random access exist, the option 1 may increase contention. Therefore, collision may also be increased, and throughput of the wireless LAN may be deteriorated, whereby the option 2 may be more efficient in a dense environment.

In this embodiment, a method for selectively using the above two options will be described.

For example, the AP may select one of the two options in accordance with a success rate of the frame received through the random access resource region. The AP may notify the STAs of the selected option. That is, the AP may notify the STAs which one of the two options should be used to perform random access.

The AP may transmit the frame (e.g., beacon frame, probe response frame, association response frame, and trigger frame), which includes RA mode information, to the STA. The RA mode information may indicate, but not limited to, mode 1 or mode 2.

Mode 1: The mode 1 is the method of the option 1. If the mode 1 is indicated, the STAs try frame transmission by randomly selecting one RU from RUs belonging to the idle channel except RU belonging to the busy channel among the RUs allocated from the trigger frame. If there is no RU belonging to the idle channel, the STAs do not transmit the frame through RU allocated from the corresponding trigger frame.

Mode 2: The mode 2 is the method of the option 2. If the mode 2 is indicated, the STAs randomly select one RU from RUs (i.e., RUs indicated by AID=0) allocated for random access from the trigger frame. The STAs transmit the frame if the selected RU belongs to the idle channel, and do not transmit the frame if the selected RU belongs to the busy channel.

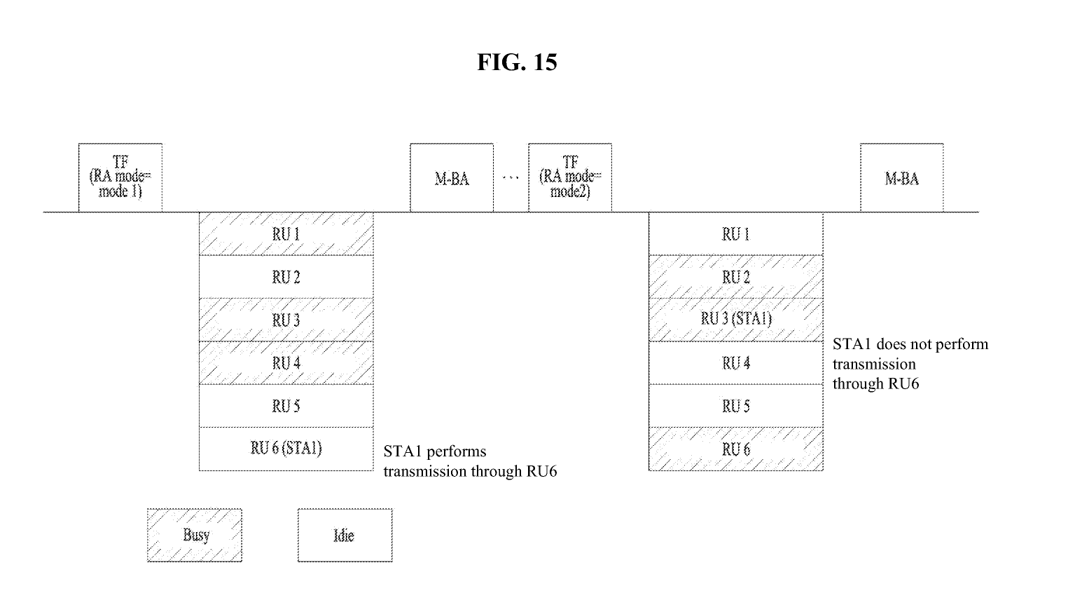

FIG. 15 is a diagram illustrating an STA operation based on an RA mode according to one embodiment of the present invention.

Referring to FIG. 15, RA mode 1 is indicated at the first TF. The STA1 transmits the frame by randomly selecting one of RU2, RU5 and RU6 belonging to the idle channel. It is assumed that the STA1 has selected RU6.

RA mode 2 is indicated at the second TF. The STA1 selects one of all RUs RU1 to RU6. Supposing that the selected RU is RU3, the STA1 does not transmit the frame through the RU3 because the RU3 belongs to the busy channel.

Meanwhile, the RA mode may be transmitted through another management frame such as beacon frame or association response instead of the trigger frame, or may be transmitted through another control frame such as ACK/Block ACK/M-BA.

For example, if RA mode indicates mode 1 in a beacon, the STAs selectively transmit RU, which belongs to the idle channel, among RUs for OFDMA random access, which are allocated from the trigger frame. Unlike this case, if RA mode indicates mode 2 in the beacon, when receiving the trigger frame, which includes OFDMA random access resource allocation, the STAs do not transmit the frame from the randomly selected RU if the selected RU belongs to the busy channel.

In this way, if RA mode is indicated using the beacon frame, it is advantageous that overhead of the trigger frame may be reduced. Meanwhile, since the beacon frame is transmitted at a relatively long period and has a semi-static attribute, it is advantageous that the method for indicating RA mode through the trigger frame may respond to a dynamic environment change more properly.

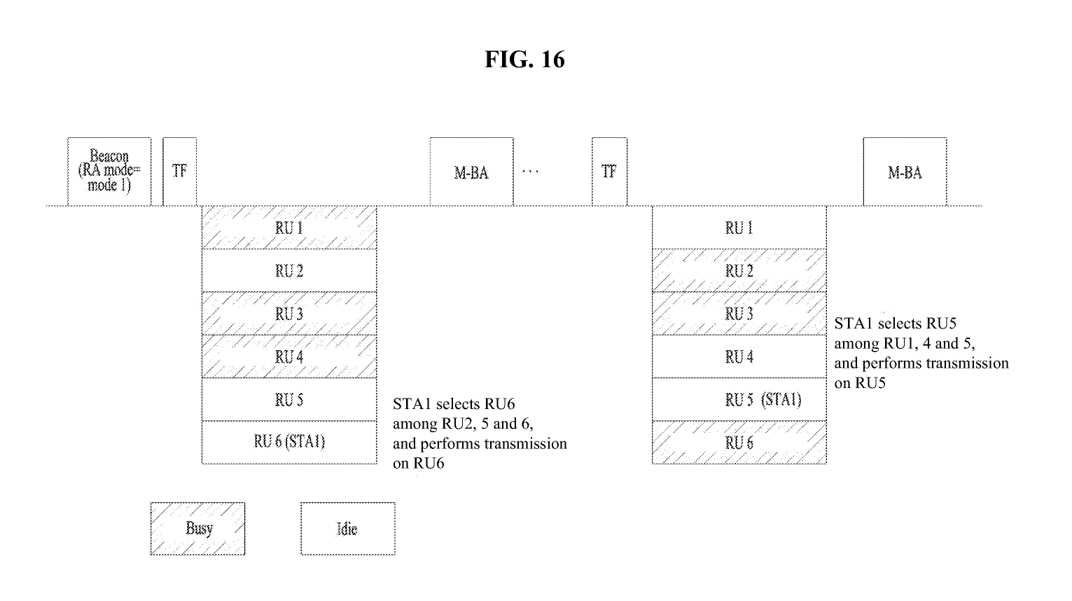

FIG. 16 is a diagram illustrating an STA operation based on an RA mode according to another embodiment of the present invention.

Referring to FIG. 16, the AP transmits the beacon frame, which includes RA mode information. If RA mode indicates mode 1 in the beacon, the STA performs random access through mode 1 when receiving TF (e.g., AID=0) for RA. The STA1 selects RU6, which is one of RUs 2, 5 and 6 belonging to the idle channel, from the first TF and transmits the frame. Afterwards, the STA1 selects RU5, which is one of RUs 1, 4 and 5 belonging to the idle channel, from the second TF and transmits the frame.

In this way, the STA continues to perform a random access procedure by using the same RA mode until it receives changed RA mode information from the AP.

CS Indication and CS Operation for Random Access

Meanwhile, in the aforementioned methods, carrier sensing performed for random access may be limited to a case that the AP indicates carrier sensing. For example, a carrier sensing (CS) required field, which indicates whether to perform carrier sensing for random access, may be defined.

The CS required field may be included in the trigger frame. The STA performs CCA for random access when the CS required field of the trigger frame is set to 1, but transmits the frame to the randomly selected RU without performing CCA when the CS required field is set to 0.

Hereinafter, a method for performing random access considering physical carrier sensing and/or virtual carrier sensing (i.e., NAV) in accordance with a value of the CS required field of the trigger frame will be suggested.

As described above, even though a physically transmitted or received signal is not detected, if a NAV timer set to the STA is non-zero, a virtual carrier sensing result corresponds to busy. For physical carrier sensing, the STA performs CCA-ED (energy detection). If a power of the detected signal exceeds a CCA threshold value, a physical carrier sensing result corresponds to busy. For example, physical carrier sensing for random access may be performed for, but not limited to, SIFS after a PPDU (physical layer protocol data unit) in which a trigger frame is included is received.

Meanwhile, the STA may support a plurality of NAVs. For example, the STA may maintain a regular NAV and an intra-BSS NAV. The regular NAV is set to protect a transmission occasion of the PPDU which is not identified whether it is inter-BSS PPDU or intra-BSS/inter-BSS. The intra BSS NAV is set to protect a transmission occasion for a PPDU from BSS to which the STA belongs. The regular NAV may be referred to as a basic NAV.

In this way, when the STA maintains the plurality of NAVs, the virtual CS may be performed based on at least one of the plurality of NAVs. For example, the virtual CS may be performed based on the regular NAV. For another example, the virtual CS may be performed considering all of the plurality of NAVs. In this case, if any one of the plurality of NAVs is not 0, the virtual CS result may be busy.

(1) When the CS required field is 0, the STA transmits RU selected by itself through a random backoff procedure based on the OBO counter and a random RU selection procedure regardless of the virtual carrier sensing result and the physical carrier sensing result (i.e., even in case of busy).

(2) When the CS required field is 1, the STA may perform OFDMA random access procedure by using one of options (i), (ii) and (iii) which will be described later, and the options are not limited to (i), (ii) and (iii).

(i) Option 1: Although the random backoff procedure and the random RU selection procedure are performed regardless of the virtual carrier sensing result and the physical carrier sensing result, whether to transmit a frame depends on the carrier sensing result. That is, if the virtual carrier sensing result and/or the physical carrier sensing result is busy, the STA does not transmit the frame.

For example, it is assumed that the CS required field is set to 1 in the trigger frame and the virtual carrier sensing result is busy (i.e., NAV timer is running) The STA reduces the OBO counter as much as RUs for random access, which are allocated from the trigger frame, by performing the random backoff procedure. If the OBO counter is 0 or reduced to 0, the STA randomly selects one of RUs for random access, which are allocated from the trigger frame. However, since the virtual carrier sensing result is busy, the STA does not transmit the frame to the selected RU.

Unlike the above case, it is assumed that the virtual carrier sensing result is idle (i.e., the case that there is no NAV, in other words, the case that NAV timer is 0). The STA reduces the OBO counter as much as RUs for random access, which are allocated from the trigger frame, by performing the random backoff procedure. If the OBO counter is 0 or reduced to 0, the STA randomly selects one of RUs for random access, which are allocated from the trigger frame. If the selected RU belongs to the busy channel (e.g., CCA-ED is busy for SIFS after PPDU in which a trigger frame is included is received) as a result of physical carrier sensing, the STA does not transmit the frame to the selected RU. If the selected RU belongs to the idle channel as a result of physical carrier sensing, the STA transmits the frame to the selected RU.

The random access procedure according to the option 1 is summarized.

If an OBO counter of HE (high efficiency) STA is smaller than the number of RUs allocated as AID value 0 from the trigger frame, the HE STA reduces the OBO counter to 0. If not so, the HE STA reduces the OBO counter as much as the same value as the number of RUs allocated as AID value 0 from the trigger frame.

If the OBO counter of the HE STA is 0 or reduced to 0, the HE STA randomly selects any one of RUs allocated as AID value 0. If a CS required sub-field is set to 0 or the selected RU is regarded as idle as a result of carrier sensing, the HE STA transmits UL PPDU from the selected RU. If the CS required sub-field is set to 1 or the selected RU is regarded as busy as a result of carrier sensing, the HE STA should not transmit UL PPDU from the selected RU, and randomly selects any one of RUs allocated as AID value 0 from the subsequent trigger frame.

If a size of the selected RU is not sufficient for PPDU transmission, the HE STA may not transmit UL PPDU from the selected RU, and randomly selects any one of RUs allocated as AID value 0 from the subsequent trigger frame.

If the OBO counter of the HE STA is not 0 and is not reduced to 0, the HE STA continues to perform the remaining OBO counter at next trigger frame for random access.

(ii) Option 2: The virtual carrier sensing result may be considered during the random backoff procedure and the random RU selection procedure but the physical carrier sensing result may not be considered. That is, the physical carrier sensing result affects frame transmission only. For example, if the virtual carrier sensing result is busy, the STA does not perform the random RU selection procedure and the random backoff procedure. The STA performs the random RU selection procedure and the random backoff procedure only if the virtual carrier sensing result is idle. If the selected RU is included in the busy channel as a result of physical carrier sensing, the STA does not transmit the frame to the selected RU.

For example, when the CS required field is set to 1 in the trigger frame and the virtual carrier sensing result is busy, the STA may allow the OBO counter to be pending without performing the random backoff procedure and the random RU selection procedure. For example, the OBO counter may be maintained without being reduced.

If the virtual carrier sensing result is idle, the STA reduces the OBO counter as much as RUs for random access, which are allocated from the trigger frame, by performing the random backoff procedure. If the OBO counter is set to 0, the STA randomly selects one of RUs for random access, which are allocated from the trigger frame. If the selected RU belongs to the busy channel as a result of physical carrier sensing, the STA does not transmit the frame to the selected RU. If the selected RU belongs to the idle channel as a result of physical carrier sensing, the STA transmits the frame to the selected RU.

The random access procedure according to the option 2 is summarized.

If the CS required sub-field is set to 1 and a value of regular NAV is not 0, the HE STA does not reduce the OBO counter. If not so, the HE STA reduces the OBO counter as much as the same value as the number of RUs allocated as AID value 0 from the trigger frame. If the OBO counter of the HE STA is smaller than the number of RUs allocated as AID value 0 from the trigger frame, the HE STA reduces the OBO counter to 0.

If the OBO counter of the HE STA is 0 or reduced to 0, the HE STA randomly selects any one of RUs allocated as AID value 0. If the CS required sub-field is set to 0 or the selected RU is regarded as idle as a result of carrier sensing, the HE STA transmits UL PPDU from the selected RU. If the CS required sub-field is set to 1 or the selected RU is regarded as busy as a result of carrier sensing, the HE STA should not transmit UL PPDU from the selected RU, and randomly selects any one of RUs allocated as AID value 0 from the subsequent trigger frame.

If a size of the selected RU is not sufficient for PPDU transmission, the HE STA may not transmit UL PPDU from the selected RU, and randomly selects any one of RUs allocated as AID value 0 from the subsequent trigger frame.

If the OBO counter of the HE STA is not 0 and is not reduced to 0, the HE STA continues to perform the remaining OBO counter at next trigger frame for random access.

(iii) Option 3: Both the virtual carrier sensing result and the physical carrier sensing result are considered during the random backoff procedure and the random RU selection procedure. For example, RUs for random access, which belong to the idle channel as a result of carrier sensing, are only considered during the random backoff procedure and the random RU selection procedure.

When the CS required field is set to 1 in the trigger frame and the virtual carrier sensing is busy, the STA allows the OBO counter to be pending without performing the random backoff procedure and the random RU selection procedure.

If the virtual carrier sensing is idle, the STA performs physical carrier sensing (e.g., CCA-ED) for SIFS after the trigger frame is received. If all RUs for random access, which are allocated from the trigger frame, belong to the busy channel as a result of physical carrier sensing, the STA allows the OBO counter to be pending without reducing the OBO counter. That is, the STA stops the random backoff procedure and the random RU selection procedure. If there are one or more RUs for random access, which belong to the idle channel, as a result of physical scarier sensing, the STA reduces the OBO counter as much as the number of RUs belonging to the idle channel. If the OBO counter is set to 0, the STA randomly selects one of RUs belonging to the idle channel and transmits the frame to the selected RU.

Meanwhile, in the aforementioned embodiments, a size of the selected RU may not be sufficient for UL PPDU transmission. At this time, the STA does not transmit UL PPDU through the selected RU. Afterwards, the STA may transmit UL PPDU by again performing the random RU selection procedure in the trigger frame for next random access.

The random access procedure according to the option 3 is summarized.

If an OBO counter of HE (high efficiency) STA is smaller than the number of RUs allocated as AID value 0 from the trigger frame and the corresponding RUs are idle as a result of carrier sensing, the HE STA reduces the OBO counter to 0. If not so, the HE STA reduces the OBO counter as much as the same value as the number of idle RUs allocated as AID value 0 from the trigger frame.

If the OBO counter of the HE STA is not 0 and is not reduced to 0, the HE STA continues to perform the remaining OBO counter at next trigger frame for random access. If there is no idle RU allocated as AID 0 from the trigger frame, the HE STA randomly selects any one of the idle RUs allocated as AID value 0 from the subsequent trigger frame.

If a size of the selected RU is not sufficient for PPDU transmission, the HE STA may not transmit UL PPDU from the selected RU, and randomly selects any one of RUs allocated as AID value 0 from the subsequent trigger frame.

If the OBO counter of the HE STA is not 0 and is not reduced to 0, the HE STA continues to perform the remaining OBO counter at next trigger frame for random access.

The options 1, 2 and 3 may be summarized as listed in Table 1.

TABLE 11

| OFDMA RA procedure | Option 1 | Option 2 | Option 3 |
|---|---|---|---|
| 1. Random backoff | Both virtual CS and | Case that virtual | Case that virtual CS is |
| | physical CS are not | CS is idle. | idle, and idle RU exists |
| | considered. | | as a result of physical |
| | | | CS. |
| 2. Random RU | Both virtual CS and | Case that virtual | Selection from |
| selection | physical CS are not | CS is idle. | idle RU |
| | considered. | | |
| 3. Frame transmission | Case that virtual CS | Case that physical | |
| through selected RU | is idle, and selected | CS is idle. | |
| | RU is idle as a result | | |
| | of physical CS. | | |

The OFDMA based random access procedure includes a random backoff procedure for deducting the OBO counter, a procedure of selecting a random RU in accordance with expiration of the OBO counter, and a procedure of transmitting a frame through the selected RU. The option, option 2 or option 3 may be identified depending on the stage of the OFDM based random access procedure, to which CS (carrier sensing) is applied. In the option 1, virtual CS and physical CS are considered during frame transmission only. In the option 2, virtual CS is only considered for random backoff and random RU selection, and physical CS is additionally considered for frame transmission. In the option 3, virtual CS and physical CS are considered during random backoff.

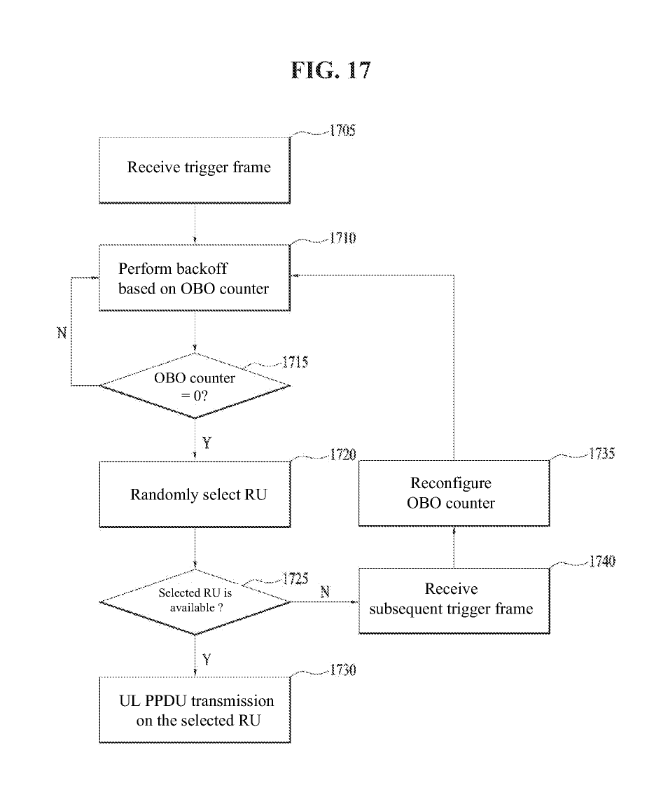

FIG. 17 is a diagram illustrating an OFDMA based random access procedure according to one embodiment of the present invention. The repeated description of the aforementioned description may be omitted.

Referring to FIG. 17, the STA receives a first trigger frame allocating at least one RU for random access among a plurality of RUs from the AP (1705).

The STA performs the backoff procedure on the basis of a first counter (e.g., OBO counter) (1710).

The STA randomly selects one of the at least one RU for random access as the first counter set to the STA becomes 0 (1720).

The STA determines whether an uplink frame can be transmitted through the randomly selected RU (1725). For example, if the randomly selected RU is busy or its size is not sufficient for transmission of the uplink frame, the STA may determine that the uplink frame cannot be transmitted.

If it is determined that the uplink frame can be transmitted through the randomly selected RU, the STA transmits UL PPDU to the selected RU (1730).

If it is determined that the uplink frame cannot be transmitted through the randomly selected RU, the STA defers UL PPDU transmission through the corresponding RU and receives a second trigger frame subsequent to the first trigger frame (1740).

The STA may reselect the RU on the basis of the second trigger frame. The STA may randomly reconfigure a first counter to reselect the RU (1735), and may defer reselection of the RU on the basis of the randomly reconfigured first counter (1710). For example, in randomly reconfiguring the first counter, the STA may reconfigure an upper limit allowed for the first counter. The reconfigured upper limit of the first counter may be two times of a current OCW (OFDMA contention window) value set to the STA or a minimum OCW value set to the STA. Alternatively, the STA may set the upper limit allowed for the first counter equally to the current OCW value set to the STA

The first trigger frame or the second trigger frame may include at least one of a first field indicating whether the STA should perform carrier sensing for random access and a second field indicating whether the STA should select only RU belonging to the idle channel except the busy channel.

Carrier sensing for random access may include at least one of virtual carrier sensing based on NAV (network allocation) and physical carrier sensing based on CCA-ED (clear channel assessment-energy detection).

Also, the backoff procedure RU based on the first counter and the RU random selection may be performed only if the NAV is 0.

Also, whether the randomly selected RU is busy may be determined based on the physical carrier sensing result.

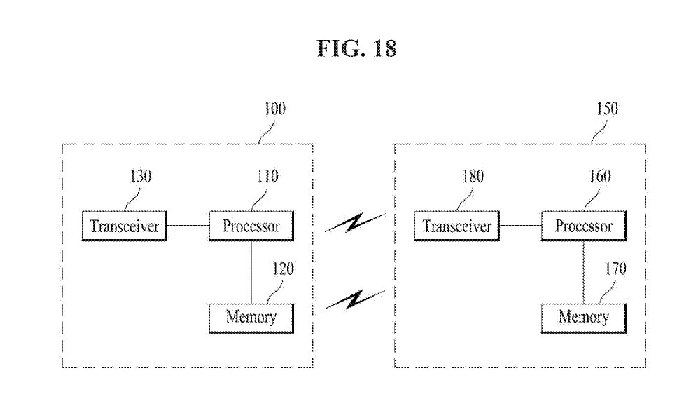

FIG. 18 is a diagram for explaining an apparatus for implementing the above-described methods.

A wireless apparatus 800 of FIG. 18 may correspond to the above-described specific STA and a wireless apparatus 850 of FIG. 18 may correspond to the above-described AP.

The STA 800 may include a processor 810, a memory 820, and a transceiver 830 and the AP 850 may include a processor 860, a memory 870, and a transceiver 880. The transceivers 830 and 880 may transmit/receive a wireless signal and may be implemented in a physical layer of IEEE 802.11/3GPP etc. The processors 810 and 860 are implemented in a physical layer and/or a MAC layer and are respectively connected to the transceivers 830 and 880. The processors 810 and 860 may perform the above-mentioned UL MU scheduling procedure.

The processors 810 and 860 and/or the transceivers 830 and 880 may include an application-specific integrated circuit (ASIC), a chipset, a logical circuit, and/or a data processor. The memories 820 and 870 may include a read-only memory (ROM), a random access memory (RAM), a flash memory, a memory card, a storage medium, and/or a storage unit. If an embodiment is performed by software, the above-described methods may be executed in the form of a module (e.g., a process or a function) performing the above-described function. The module may be stored in the memories 820 and 870 and be executed by the processors 810 and 860. The memories 820 and 870 may be located at the interior or exterior of the processors 810 and 860 and may be connected to the processors 810 and 860 via known means.

The detailed description of the exemplary embodiments of the present invention has been given to enable those skilled in the art to implement and practice the invention. Although the invention has been described with reference to the preferred embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

While the above description has been given under the assumption that the invention is applied to an IEEE 802.11 based WLAN system, the present invention is not limited thereto. The present invention is identically applicable to various wireless systems capable of performing contention-based random access.

1. A method for performing random access to an access point (AP) by a station (STA) operating in a wireless local area network (WLAN) system, the method comprising:
receiving a first trigger frame allocating at least one resource unit (RU) for random access among a plurality of RUs;
randomly selecting one of the at least one RU for random access when a first counter configured in the STA becomes 0; and
reselecting a RU based on a second trigger frame subsequent to the first trigger frame when it is determined that an uplink frame cannot be transmitted through the randomly selected RU,
wherein in reselecting the RU, the STA randomly reconfigures the first counter and defers the reselection of the RU based on the randomly reconfigured first counter.

2. The method according to claim 1, wherein a current OFDMA contention window (OCW) value set to the STA is used for randomly reconfiguring the first counter.

3. The method according to claim 1,
wherein in randomly reconfiguring the first counter, the STA reconfigures an upper limit allowed for the first counter, and
wherein the reconfigured upper limit of the first counter corresponds to two times of the current OCW value set to the STA or a minimum OCW value set to the STA.

4. The method according to claim 1, wherein the STA determines that the uplink frame cannot be transmitted when the randomly selected RU is busy as a result of carrier sensing.

5. The method according to claim 1, wherein the first trigger frame or the second trigger frame includes at least one of a first field indicating whether the STA should perform carrier sensing for random access and a second field indicating whether the STA should select only RU belonging to an idle channel except a busy channel.

6. The method according to claim 4, wherein the carrier sensing includes at least one of virtual carrier sensing based on network allocation (NAV) and physical carrier sensing based on clear channel assessment-energy detection (CCA-ED).

7. The method according to claim 6, wherein a backoff procedure based on the first counter and the random selection of the RU are performed only when the NAV is 0.

8. The method according to claim 6, wherein whether the randomly selected RU is busy is determined based on a result of the physical carrier sensing.

9. A station (STA) for performing random access in a wireless local area network (WLAN) system, the STA comprising:
a receiver for receiving a first trigger frame allocating at least one resource unit (RU) for random access among a plurality of RUs; and
a processor for randomly selecting one of the at least one RU for random access when a first counter configured in the STA becomes 0, and reselecting a RU on based on a second trigger frame subsequent to the first trigger frame when it is determined that an uplink frame cannot be transmitted through the randomly selected RU,
wherein in reselecting the RU, the processor randomly reconfigures the first counter and defers the reselection of the RU on based on the randomly reconfigured first counter.

10. The STA according to claim 9, wherein a current OFDMA contention window (OCW) value set to the STA is used for randomly reconfiguring the first counter.

11. The STA according to claim 9,
wherein in randomly reconfiguring the first counter, the processor reconfigures an upper limit allowed for the first counter, and
wherein the reconfigured upper limit of the first counter corresponds to two times of the current OCW value set to the STA or a minimum OCW value set to the STA.

12. The STA according to claim 9, wherein the processor determines that the uplink frame cannot be transmitted when the randomly selected RU is busy as a result of carrier sensing.

13. The STA according to claim 9, wherein the first trigger frame or the second trigger frame includes at least one of a first field indicating whether the STA should perform carrier sensing for random access and a second field indicating whether the STA should select only RU belonging to an idle channel except a busy channel.

14. The STA according to claim 12, wherein the carrier sensing includes at least one of virtual carrier sensing based on network allocation (NAV) and physical carrier sensing based on clear channel assessment-energy detection (CCA-ED).

15. The STA according to claim 14, wherein a backoff procedure based on the first counter and the random selection of the RU are performed only when the NAV is 0, and whether the randomly selected RU is busy is determined based on a result of the physical carrier sensing.
